(19) United States
(12) Patent Application Publication
(10) Pub. No.: US 2015/0353119 A1
(43) Pub. Date: Dec. 10, 2015

(54) STEERING WHEEL STRUCTURE

(71) Applicant: KABUSHIKI KAISHA TOKAI-RIKA-DENKI-SEISAKUSHO, Aichi-ken (JP)

(72) Inventor: Hiroshi OHIRA, Aichi-ken (JP)

(21) Appl. No.: 14/729,329

(22) Filed: Jun. 3, 2015

(30) Foreign Application Priority Data
Jun. 6, 2014 (JP) 2014-117975

(51) Int. Cl. B62D 1/06

(52) U.S. Cl. CPC B62D 1/06

(57) ABSTRACT

An inner face portion of a first heat generating body and an inner face portion of a second heat generating body, configuring a steering wheel, are respectively disposed facing a surface portion of a rim core metal section via a space portion. Configuring the space portion in a hollow state enables the inner face portion of the first heat generating body and the inner face portion of the second heat generating body to be configured in a non-constrained state. Accordingly, difference in deformation amounts between an outer face portion and the inner face portion of the first heat generating body can be suppressed from occurring when the first heat generating body generates heat. Moreover, difference in deformation amounts between an outer face portion and the inner face portion of the second heat generating body can be suppressed from occurring when the second heat generating body generates heat.

### CROSS-REFERENCE TO RELATED APPLICATION

This application claims priority under 35 USC 119 from Japanese Patent Application No. 2014-117975 filed Jun. 6, 2014, the disclosure of which is incorporated by reference herein.

### BACKGROUND

1. Field of the Invention

The present invention relates to a steering wheel structure.

2. Related Art

Japanese Patent Application Laid-Open (JP-A) No. 2010-36840 (referred to below as Patent Document 1) describes technology relating to a steering wheel. In this related art, a heat generating body is disposed at an inner face, namely a face that faces a rim core metal side, of a decorative member gripped by an occupant of the vehicle. The heat generating body generates heat when a switch installed to the steering wheel is operated. Operating the switch such that the heat generating body generates heat enables the decorative member to be warmed, even when the decorative member has become cold due to being at low temperature surroundings. A low thermal conduction member is disposed between the rim core metal and the heat generating body, enabling transmission of the heat generated by the heat generating body to the rim core metal to be suppressed.

However, in the related art described in Patent Document 1, the coefficient of linear (thermal) expansion of the decorative member and the coefficient of linear expansion of the low thermal conduction member differ from each other, and so load can sometimes act on the heat generating body when warming the decorative member with the heat generating body.

More specifically, in the steering wheel described in Patent Document 1, the decorative member and the low thermal conduction member are configured with different materials from each other. Moreover, configuration is made such that the decorative member is affixed to one face of the heat generating body, and the low thermal conduction member is affixed to another face of the heat generating body. Namely, the one face side and the another face side of the heat generating body are in a constrained state between members having different coefficients of linear expansion to each other.

When the decorative member is warmed by the heat generating body, the low thermal conduction member is also warmed, and both the decorative member and the low thermal conduction member undergo thermal expansion. However, due to the difference between the coefficients of linear expansion of these respective members, a difference arises between the deformation amount of the decorative member and the deformation amount of the low thermal conduction member due to the thermal expansion. A difference accordingly arises between a deformation amount of the one face side of the heat generating body that deforms under the influence of the thermal expansion of the decorative member, and a deformation amount of the another face side of the heat generating body that deforms under the influence of the thermal expansion of the low thermal conduction member. Shear stress therefore arises in the heat generating body, and this shear stress imparts load on the heat generating body.

### SUMMARY

In consideration of the above circumstances, a steering wheel structure that enables a decorative member to be warmed, while suppressing load on a heat generating body, is provided.

A steering wheel structure according to a first aspect includes: a rim core metal section that configures a portion of a frame of a steering wheel; a decorative member that covers the rim core metal section, and that is gripped by an occupant; and a heat generating body that includes an outer face portion which is joined to an inner peripheral face portion of the decorative member via a joining member and which transmits heat to the decorative member, and that includes an inner face portion which is disposed facing a surface portion of the rim core metal section via a space portion.

According to the first aspect, the rim core metal section configuring a portion of the frame of the steering wheel is covered by the decorative member that is gripped by the occupant. The inner peripheral face portion of the decorative member is joined to the outer face portion of the heat generating body via the joining member, and heat is transmitted from the heat generating body and the decorative member is heated when the heat generating body generates heat. The occupant can accordingly grip the decorative member in a warmed state of the decorative member, even when the decorative member has become cold due to exposure to low temperature surroundings.

Note that in a case in which members are affixed to the outer face portion and the inner face portion of the heat generating body, and these members have different material to each other, the outer face portion and the inner face portion could be constrained by the members that have different coefficients of linear expansion. Due to the difference between the coefficients of linear expansion of these members, different deformation amounts at the outer face portion of the heat generating body and the inner face portion of the heat generating body when the heat generating body generates heat arise, thereby load acting on the heat generating body.

In the aspect, the inner face portion of the heat generating body is disposed facing a surface portion of the rim core metal via the space portion. Configuring the space portion in a hollow state in this manner enables the inner face portion of the heat generating body to be configured in a non-constrained state. This thereby enables a difference in deformation amounts to be suppressed from arising between the outer face portion of the heat generating body and the inner face portion of the heat generating body when the heat generating body generates heat.

A steering wheel structure according to a second aspect includes: a rim core metal section that configures a portion of a frame of a steering wheel; a decorative member that covers the rim core metal section, and that is gripped by an occupant; and a heat generating body that includes an outer face portion which abuts an inner peripheral face portion of the decorative member so as to be capable of relative displacement with respect to the inner peripheral face portion of the decorative member and which transmits heat to the decorative member, and that includes an inner face portion which is disposed facing a surface portion of the rim core metal via a space portion.

The second aspect of the present invention has the same basic configuration as the first aspect, and exhibits similar operation thereto. However, in the aspect, the inner peripheral face portion of the decorative member and the outer face portion of the heat generating body abut each other so as to be capable of relative displacement, thereby enabling the outer face portion of the heat generating body to be configured in a non-contacting state.

In a steering wheel structure according to a third aspect in the first aspect or the second aspect of the invention, resilient members that press the heat generating body toward the decorative member side, the resilient members being disposed between the surface portion and the inner face portion, and are disposed at a plurality of locations in an axial direction of the rim core metal section.

According to the third aspect of the present invention, the resilient members are disposed between the surface portion of the rim core metal section and the inner face portion of the heat generating body at plural locations in the axial direction of the rim core metal section, enabling the heat generating body to be disposed in a stable state with respect to the rim core metal section. The heat generating body is pressed by the resilient member, pressing the heat generating body against the decorative member, enabling heat to be efficiently transmitted from the heat generating body to the decorative member.

In a steering wheel structure according to a fourth aspect in any one of the first aspect to the third aspect, insertion holes are formed at the heat generating body at a plurality of locations in an axial direction of the rim core metal section; a plurality of support portions projecting out toward the decorative member side are provided at the surface portion so as to correspond to the insertion holes in the axial direction of the rim core metal; and the decorative member is fixed to leading end portions of the support portions which are inserted through the insertion holes.

According to the fourth aspect of the present invention, the heat generating body is formed with the insertion holes at plural locations in the axial direction of the rim core metal section. The surface portion of the rim core metal section is provided with the plural support portions projecting out toward the decorative member side so as to correspond to the insertion holes in the axial direction of the rim core metal section. The support portions are inserted through the insertion holes, and the decorative member is fixed to the leading end portions of the support portions. This thereby enables the decorative member to be stably supported with respect to the rim core metal section, without the rim core metal section contacting the heat generating body.

In a steering wheel structure according to a fifth aspect in the any one of the first aspect to the forth aspect, notches are formed at the heat generating body at a plurality of locations in an axial direction of the rim core metal section; a plurality of spacer members are disposed on the rim core metal so as to correspond to the notches in the axial direction of the rim core metal section; and exposed portions of the spacer members which are exposed through the notches abut the decorative member.

According to the fifth aspect, the heat generating body is formed with the notches at plural locations in the axial direction of the rim core metal section, and the plural spacer members are disposed on the rim core metal section so as to correspond to the notches in the axial direction of the rim core metal. The exposed portions of the spacer members which are exposed through the notches abut the decorative member. This thereby enables relative displacement of the decorative member with respect to the rim core metal section about the axial direction of the rim core metal section to be suppressed.

As described above, the steering wheel structure of the aspects exhibits the excellent advantageous effect of enabling the decorative member to be warmed, while suppressing load on the heat generating body.

### BRIEF DESCRIPTION OF THE DRAWINGS

An exemplary embodiment will be described in detail with reference to the following figures, wherein:

FIG. 1 is an exploded perspective view showing a structure of a second grip portion of a steering wheel according to an exemplary embodiment;

FIG. 2 is an enlarged cross-section (a cross-section showing a state cut away along line 2-2 in FIG. 4) showing a structure of a second grip portion of a steering wheel according to the present exemplary embodiment;

FIG. 3 is an enlarged cross-section (a cross-section showing a state cut away along line 3-3 in FIG. 4) showing a structure of a second grip portion of a steering wheel according to the present exemplary embodiment;

FIG. 4 is a front view of a steering wheel according to the present exemplary embodiment, as viewed by a driver in a seated state in the driving seat of a vehicle; and

FIG. 5 is an enlarged cross-section showing a structure of a second grip portion of a steering wheel according to the present exemplary embodiment.

### DETAILED DESCRIPTION

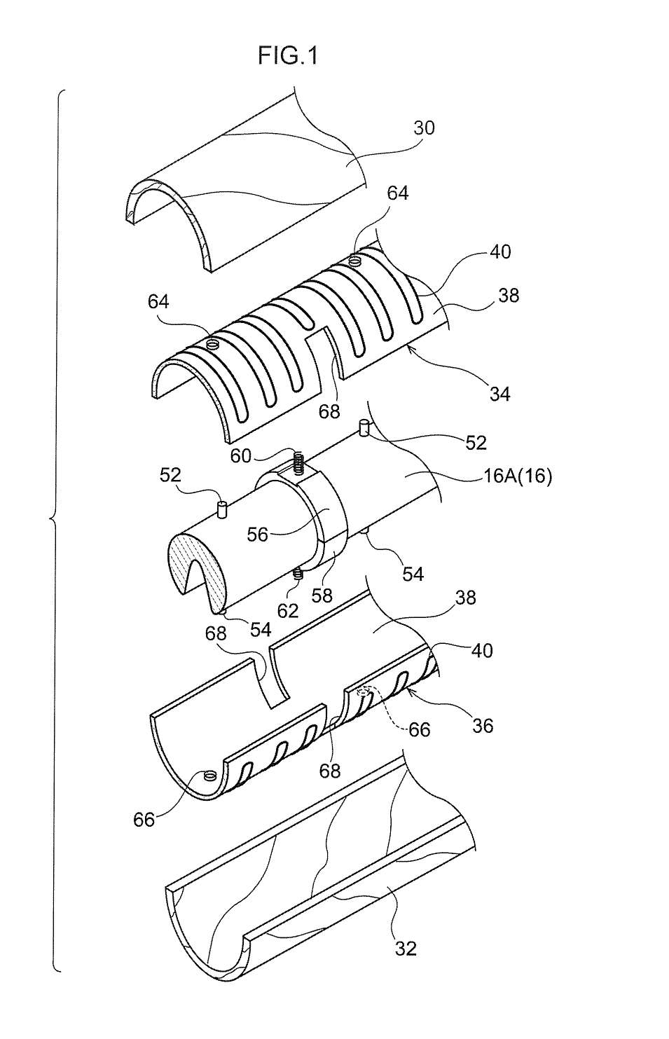

Explanation follows regarding an example of a steering wheel 10 applied with a steering wheel structure according to the disclosure, with reference to FIG. 1 to FIG. 4. Note that in each of the drawings, the arrow FR, the arrow UP, and the arrow IN respectively indicate the vehicle front side, the vehicle upper side, and the vehicle width direction inside as appropriate. Moreover, the arrow R1 in the drawings indicates a radial direction outside of a rim core metal section 16 (referred to below as the rim radial direction outside), and the arrow R2 in the drawings indicates a radial direction inside of the rim core metal section 16 (referred to below as the rim radial direction inside), described below, as appropriate.

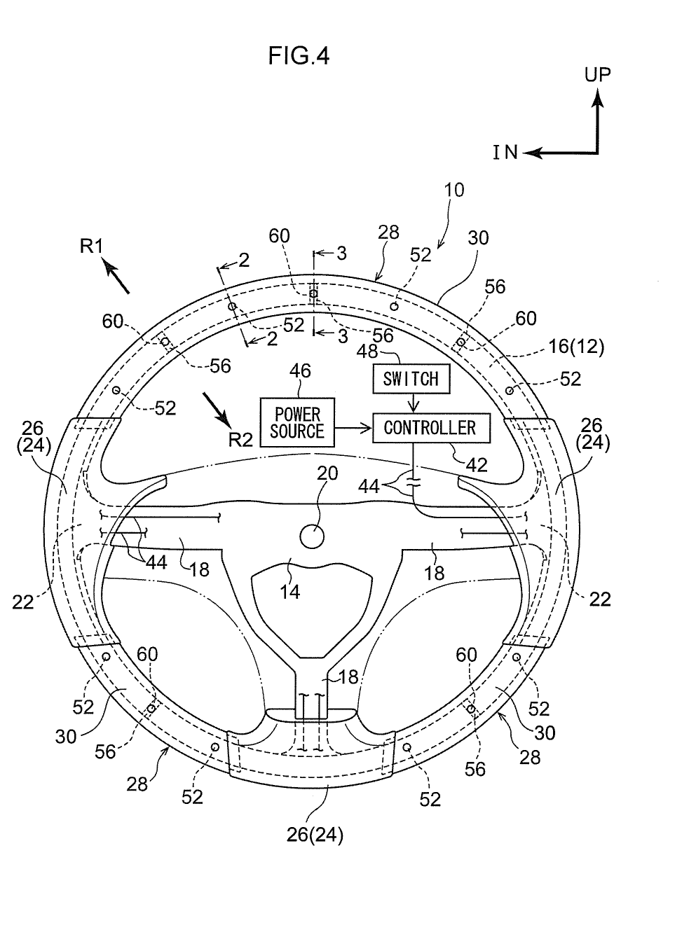

The steering wheel 10 according to the present exemplary embodiment configures vehicle steering apparatus, and the steering wheel 10 is disposed facing the vehicle driving seat. The steering wheel 10 can be rotation operated in an axial direction (curve direction) of a rim core metal section 16 (referred to below as the rim core metal axial direction) by an occupant seated in the driving seat (referred to below simply as the “occupant”). As shown in FIG. 4, a frame section of the steering wheel 10 is configured by a core metal 12. The core metal 12 is configured including a boss section 14, the rim core metal section 16, and spoke sections 18, and is formed from alloy material by molding (casting). In the present exemplary embodiment, as an example, the core metal 12 is configured from an aluminum alloy.

The boss section 14 configures a central portion of the core metal 12, and is fixed to one end portion (a leading end portion) of a steering shaft (steering axis) 20 configuring the vehicle steering apparatus (steering device). As viewed by the occupant, the rim core metal section 16 is formed in a circular ring shape centered on the boss section 14, and configures an outer peripheral portion of the core metal 12. The rim core metal section 16 is solid at portions where first support portions 52 and second support portions 54, described later, are provided, but has a bifurcated shape (fork end shape) in cross-section taken along the axial direction of the steering shaft 20 (referred to below as the steering axial direction) at other portions. More specifically, the cross-section profile of the rim core metal section 16 taken along the steering axial direction is a C-shape, open toward another end portion (a base end portion) side of the steering shaft 20. The spoke sections 18 are disposed between the boss section 14 and the rim core metal section 16.

Plural of the spoke sections 18 are disposed between the boss section 14 and the rim core metal section 16, and are coupled to the boss section 14 and the rim core metal section 16. In other words, the boss section 14, the rim core metal section 16, and the spoke sections 18 are formed integrally to each other. Namely, when the rim core metal section 16 is rotated about the steering axis, the boss section 14 is rotated via the spoke sections 18, and the steering shaft 20 fixed to the boss section 14 rotates about the steering axis.

In the core metal 12 configured as described above, respective joint portions 22, each including a location on the rim core metal section 16 side of the respective spoke section 18, and a joint location of the rim core metal section 16 to the spoke section 18, are covered by first grip portions 24. Portions of the rim core metal section 16 that are not covered by the first grip portions 24 are covered by second grip portions 28, described later.

The first grip portions 24 are each configured including a first cover member 26, and a second side cover member, not shown in the drawings, and can be gripped by the occupant during operation of the steering wheel 10. More specifically, the first cover member 26 and the second side cover member are each formed in half-tube shapes, and the first cover member 26 covers the joint portion 22 at one end portion side in the steering axial direction (a vehicle rear side). The second side cover member covers the joint portion 22 at another end portion side in the steering axial direction (a vehicle front side).

The first cover member 26 and the second side cover member are stitched together and assembled to the core metal 12 so as to cover the entire periphery of the joint portion 22. As an example, the first cover member 26 and the second side cover member are configured from a leather material (outer leather material) that is hard to slip during operation, is pleasing to the touch, and has excellent decorative characteristics and a sense of quality. Note that the leather material configuring the first cover member 26 and the second side cover member may be genuine leather, or may be synthetic leather.

As shown in FIG. 1, the second grip portion 28 is configured including a first decorative member 30 and a second decorative member 32, serving as decorative member, and a first heat generating body 34 (heater) and a second heat generating body (heater) 36, serving as heat generating body. Of these, the first decorative member 30 and the second decorative member 32 can be gripped by the occupant during operation of the steering wheel 10.

More specifically, the first decorative member 30 and the second decorative member 32 are respectively formed in half-tube shapes, and extend in the rim core metal axial direction. The first decorative member 30 covers the rim core metal section 16 on the one end portion side in the steering axial direction, and the second decorative member 32 covers the rim core metal section 16 on the another end portion side in the steering axial direction.

The first decorative member 30 and the second decorative member 32 are, as an example, formed from a wood material (real wood) that is hard to slip during operation, is pleasing to the touch, and has excellent decorative characteristics. More specifically, in order to show a sense of quality, the first decorative member 30 and the second decorative member 32 employ a wood material with a surface woodgrain pattern. Note that instead of a wood material, the first decorative member 30 and the second decorative member 32 may employ a resin material surfaced with a woodgrain finish, a metallic finish, a carbon finish, or the like.

Respective edge portions of the first decorative member 30 and the second decorative member 32, extending in the rim core metal axial direction, are, as an example, bonded together using a resin-based adhesive for wood, not shown in the drawings, in order to assemble the first decorative member 30 and the second decorative member 32 to the core metal 12 so as to cover the entire periphery of the rim core metal section 16 in a tube shape. In the following explanation, unless specifically stated otherwise, “adhesive” refers to a resin-based adhesive for wood.

As an example, the first heat generating body 34 is configured including a sheet (film) 38 formed in a rectangular shape with length direction thereof in the rim core metal axial direction, and a heating wire 40 configured from a nichrome wire and which is laid out snaking manner (meander manner) over the surface of the sheet 38. The first heat generating body 34 is disposed along an inner peripheral face portion 30A of the first decorative member 30 that faces the rim core metal section 16.

Similarly to the first heat generating body 34, the second heat generating body 36 is also configured including a sheet 38 and a heating wire 40, and is disposed along an inner peripheral face portion 32A of the second decorative member 32 that faces the rim core metal section 16.

When current flows through the heating wires 40 of the first heat generating body 34 and the second heat generating body 36 configured as described above, the heating wires 40 generate heat, enabling the first decorative member 30 and the second decorative member 32 to be heated. Note that each sheet 38 is formed with a base of a resin sheet or a rubber sheet, and is set with a thickness to enable face-to-face contact with the inner peripheral face portion 30A of the first heat generating body 34 and the inner peripheral face portion 32A of the second decorative member 32.

The first heat generating body 34 and the second heat generating body 36 are electrically connected, in series or in parallel. In other words, configuration is made such that when current flows through the first heat generating body 34, current also flows through the second heat generating body 36. Moreover, as shown in FIG. 4, the first heat generating body 34 and the second heat generating body 36 are electrically connected to a controller 42 via a harness (wire) 44. Note that connecting wires, not shown in the drawings, provided at end portions of the respective heating wires 40 of the first heat generating body 34 and the second heat generating body 36, are connected to the harness 44.

A power source 46 and a switch 48 are connected to the controller 42. Configuration is made such that when the switch 48 is conducted (ON), current flows from the power source 46, through the controller 42, into the harness 44. Note that a battery installed in the vehicle, for example, may be appropriately employed as the power source 46.

Note that in the present exemplary embodiment, the rim core metal section 16 is provided with the first support portions 52 and the second support portions 54, serving as support portion. A first feature in the present exemplary embodiment is that the first decorative member 30 is supported by the first support portions 52, and the second decorative member 32 is supported by the second support portions 54 respectively. A second feature is that first spacer members 56 and second spacer members 58, serving as spacer member, are respectively interposed between the first decorative member 30 and the rim core metal section 16, and the second decorative member 32 and the rim core metal section 16. Moreover, a third feature is that the first heat generating body 34 and the second heat generating body 36 are respectively supported by coil springs 60 and 62, serving as resilient (elastic) member.

Explanation follows regarding main portions, focusing on the first support portions 52, the second support portions 54, the first spacer members 56, the second spacer members 58, and the coil springs 60 and 62.

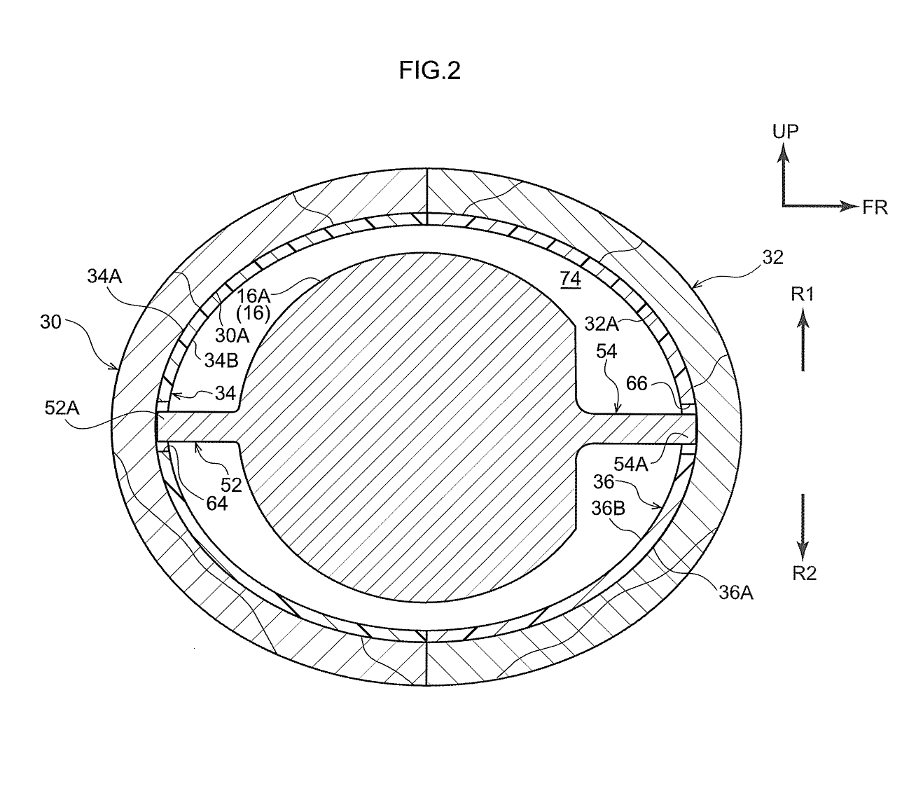

As shown in FIG. 1 and FIG. 4, the first support portions 52 and the second support portions 54 are formed in circular columnar shapes, and are disposed at plural locations at the same intervals in the rim core metal axial direction. More specifically, as shown in FIG. 2, the first support portion 52 is provided at a surface portion 16A of the rim core metal section 16 on the one end portion side in the steering axial direction, and project out from the surface portion 16A toward the first decorative member 30 side. The second support portion 54 is provided at the surface portion 16A of the rim core metal section 16 on the another end portion side in the steering axial direction, and project out from the surface portion 16A toward the second decorative member 32 side.

The first heat generating body 34 is provided with respective insertion holes 64 corresponding to the first support portions 52, and set with a larger diameter than the diameter of the first support portions 52, and the second heat generating body 36 is provided with respective insertion holes 66 corresponding to the second support portions 54, and set with a larger diameter than the diameter of the second support portions 54. Namely, the insertion holes 64 and the insertion holes 66 are disposed at plural locations at the same intervals in the rim core metal axial direction. Note that in the above configuration, the first support portion 52 and the second support portion 54 may also be understood as being provided corresponding to the insertion holes 64 and the insertion holes 66 in the rim core metal axial direction.

The first support portion 52 is inserted through the insertion hole 64 in a non-contacting state therebetween, and the first decorative member 30 is joined to the leading end portion 52A of the first support portion 52 using an adhesive, thereby fixing the first decorative member 30 to the leading end portion 52A. The second support portion 54 is inserted through the insertion hole 66 in a non-contacting state therebetween, and the second decorative member 32 is joined to the leading end portion 54A of the second support portion 54 using an adhesive, thereby fixing the second decorative member 32 to the leading end portion 54A.

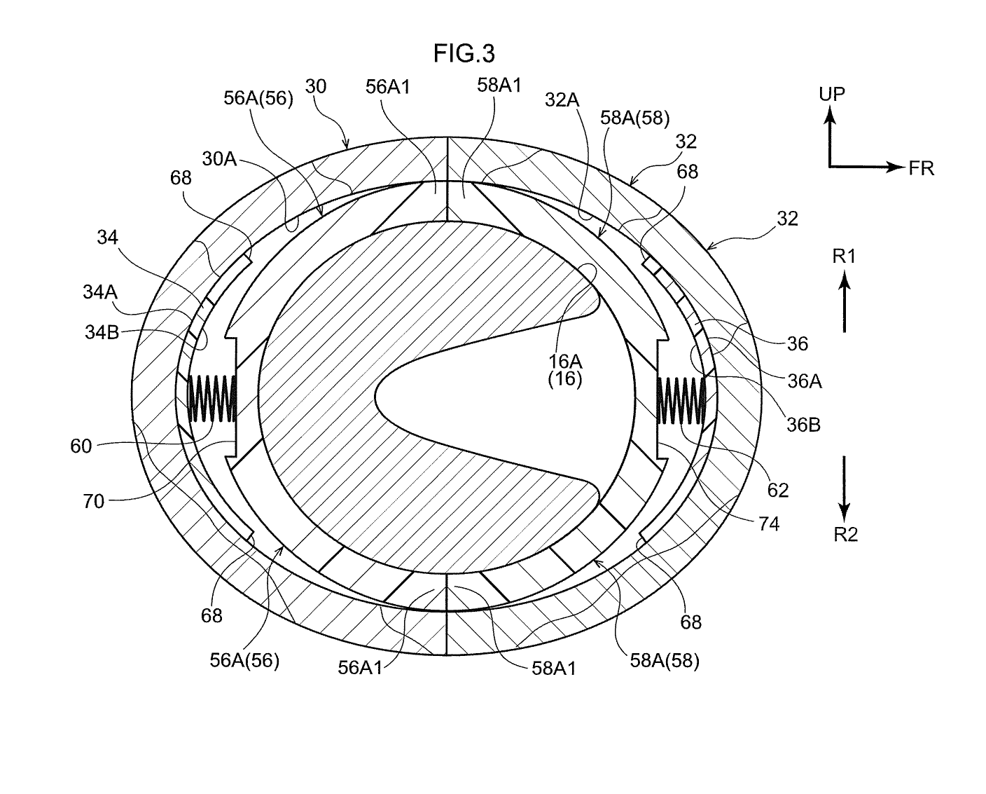

Next, in FIG. 1, explanation follows regarding configuration of the first spacer members 56 and the second spacer members 58. In the first spacer members 56 and the second spacer members 58, each one of the first spacer members 56 and each one of second spacer members 58 configure each one set (one group) (namely, plural sets each having one first spacer member 56 and one second spacer member 58), and in each set, the first spacer member 56 and the second spacer member 58 are joined to the surface portion 16A of the rim core metal section 16 using an adhesive. More specifically, as shown in FIG. 3, the first spacer member 56 and the second spacer member 58 are formed so as to form a circular cylinder shape with axial direction running in the axial direction of the rim core metal section 16 in an assembled state assembled to the rim core metal section 16. Namely, the first spacer member 56 and the second spacer member 58 are respectively formed in circular cylinder half shapes. The first spacer members 56 and the second spacer members 58 are disposed at plural locations at the same intervals in the rim core metal axial direction, and more specifically, are respectively disposed at intermediate positions between the first support portions 52, and intermediate positions between the second support portions 54.

Notch sections 68, rectangular notch shaped as viewed along a rim radial direction, are formed at the first heat generating body 34 and the second heat generating body 36 at positions facing substantially toward the rim radial direction inside and the rim radial direction outside of the first spacer members 56 and the second spacer members 58. Namely, one notch section 68 is formed at the first heat generating body 34 at a position substantially facing toward the rim radial direction inside of the first spacer member 56 and another notch section 68 is formed at the first heat generating body 34 at a position substantially facing toward the rim radial direction outside of the first spacer member 56, further, one notch section 68 is formed at the second heat generating body 36 at a position substantially facing toward the rim radial direction inside of the second spacer member 58 and another notch section 68 is formed at the second heat generating body 36 at a position substantially facing toward the rim radial direction outside of the second spacer member 58. Namely, the notch sections 68 are disposed at plural locations at the same intervals in the rim core metal axial direction, and more specifically, are disposed at intermediate positions between the first support portions 52, and intermediate positions between the second support portions 54. In the above configuration, the first spacer members 56 and the second spacer members 58 may also be understood as being disposed corresponding to the notch sections 68 in the rim core metal axial direction.

Rim radial direction inside portions and rim radial direction outside portions of the first spacer members 56 are exposed through the notch sections 68 (these exposed portions are referred to below as the “exposed portions 56A”). Further, rim radial direction inside portions and rim radial direction outside portions of the second spacer members 58 are exposed through the notch sections 68 (these exposed portions are referred to below as the “exposed portions 58A”). End portions 56A1 of the exposed portions 56A abut the inner peripheral face portion 30A of the first decorative member 30, and end portions 58A1 of the exposed portions 58A abut the inner peripheral face portion 32A of the second decorative member 32. The abut surface area between the end portion 56A1 and the inner face portion 30A, and the abut surface area between the end portion 58A1 and the inner peripheral face portion 32A can be adjusted appropriately by modifying the shapes of the first spacer members 56 and the second spacer members 58.

A flat face portion 70 is formed at each of the first spacer members 56 on the one end portion side in the steering axial direction, and the coil springs 60 are disposed on the flat face portions 70. A flat face portion 72 is formed at each of the second spacer members 58 on the another end portion side in the steering axial direction, and the coil springs 62 are disposed on the flat face portions 72.

As shown in FIG. 3, the coil springs 60 are interposed between the flat face portions 70 of the first spacer members 56 and the first heat generating body 34. A leading end portion of each of the coil springs 60 is fixed to the first heat generating body 34 using an adhesive or the like, and a base end portion of each of the coil springs 60 is anchored to an anchor portion, not shown in the drawings, provided at the flat face portion 70. The coil spring 60 accordingly presses the first heat generating body 34 toward the one end portion side in the steering axial direction, thereby pressing the first heat generating body 34 against the first decorative member 30.

The coil springs 62 are interposed between the flat face portions 72 of the second spacer members 58 and the second heat generating body 36. A leading end portion of each of the coil springs 62 is fixed to the second heat generating body 36 using an adhesive or the like, and a base end portion of each of the coil springs 62 is anchored to an anchor portion, not shown in the drawings, provided at the flat face portion 72. The coil spring 62 accordingly presses the second heat generating body 36 toward the another end portion side in the steering axial direction, thereby pressing the second heat generating body 36 against the second decorative member 32, similarly to the first heat generating body 34.

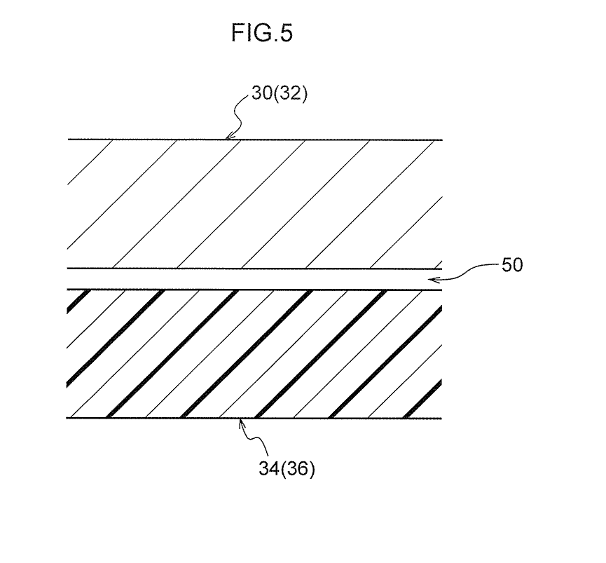

In the present exemplary embodiment, an outer face portion 34A of the first heat generating body 34 and the inner peripheral face portion 30A of the first decorative member 30, and an outer face portion 36A of the second heat generating body 36 and the inner peripheral face portion 32A of the second decorative member 32, are respectively joined together via a joining member such as an adhesive 50 (FIG. 5). Moreover, in the present exemplary embodiment, an inner face portion 34B of the first heat generating body 34 that faces toward the another end portion side in the steering axial direction, and an inner face portion 36B of the second heat generating body 36 that faces toward the one end portion side in the steering axial direction, are respectively disposed facing the surface portion 16A of the rim core metal section 16.

In the second grip portion 28 configured as described above, the rim core metal section 16 is in a separated state from the first heat generating body 34 and the second heat generating body 36. More specifically, as shown in FIG. 2, a space portion 74 is formed between the inner face portion 34B of the first heat generating body 34 and the inner face portion 36B of the second heat generating body 36, and the surface portion 16A of the rim core metal section 16. This may also be understood in terms of the inner face portion 34B of the first heat generating body 34 and the inner face portion 36B of the second heat generating body 36, being disposed facing the surface portion 16A of the rim core metal section 16 via the space portion 74.

### Operation and Advantageous Effects of the Present Exemplary Embodiment

Explanation follows regarding operation and advantageous effects of the present exemplary embodiment.

As shown in FIG. 1 to FIG. 3, in the present exemplary embodiment, the rim core metal section 16 that configures a portion of the frame of the steering wheel 10 is covered by the first decorative member 30 and the second decorative member 32 that are gripped by the occupant. The inner peripheral face portion 30A of the first decorative member 30 is joined to the outer face portion 34A of the first heat generating body 34 via the adhesive, and the inner peripheral face portion 32A of the second decorative member 32 is joined to the outer face portion 36A of the second heat generating body 36 via the adhesive. When the first heat generating body 34 and the second heat generating body 36 generate heat, the heats from the first heat generating body 34 and the second heat generating body 36 are transmitted to heat the first decorative member 30 and the second decorative member 32. The occupant can accordingly grip the first decorative member 30 and the second decorative member 32 in a warmed state of the first decorative member 30 and the second decorative member 32 even when the first decorative member 30 and the second decorative member 32 have become cold due to exposure to low temperature surroundings.

For respective members affixed to the outer face portions 34A, 36A and the inner face portions 34B, 36B of the first heat generating body 34 and the second heat generating body 36, sometimes these members have different materials (material properties). In such a case, the outer face portions 34A, 36A and the inner face portions 34B, 36B of the first heat generating body 34 and the second heat generating body 36 would be constrained by members with different linear expansion rates. The difference between the coefficients of linear expansion of these members results in different deformation amounts between the outer face portion 34A and the inner face portion 34B of the first heat generating body 34 when the first heat generating body 34 generates heat. Different deformation amounts also arise between the outer face portion 36A and the inner face portion 36B of the second heat generating body 36 when the second heat generating body 36 generates heat.

Note that in the present exemplary embodiment, the inner face portion 34B of the first heat generating body 34 and the inner face portion 36B of the second heat generating body 36 are respectively disposed facing the surface portion 16A of the rim core metal section 16 via the space portion 74. Configuring the space portion 74 in a hollow state (a gap is formed between the inner face portion 34B of the first heat generating body 34 and the inner face portion 36B of the second heat generating body 36, and the surface portion 16A of the rim core metal section 16) enables the inner face portion 34B of the first heat generating body 34 and the inner face portion 36B of the second heat generating body 36 to be configured in a non-constrained state. This thereby enables a difference in deformation amounts between the outer face portion 34A and the inner face portion 34B of the first heat generating body 34 to be suppressed from arising when the first heat generating body 34 generates heat. This also enables a difference in deformation amounts between the outer face portion 36A and the inner face portion 36B of the second heat generating body 36 to be suppressed from arising when the second heat generating body 36 generates heat.

Moreover, in the present exemplary embodiment, the outer face portion 34A of the first heat generating body 34 is joined to the inner peripheral face portion 30A of the first decorative member 30, and the outer face portion 36A of the second heat generating body 36 is joined to the inner peripheral face portion 32A of the second decorative member 32, via an adhesive, not shown in the drawings. The contact surface area between the first heat generating body 34 and the first decorative member 30, and the contact surface area between the second heat generating body 36 and the second decorative member 32, can be secured (obtained) since the first heat generating body 34 and the first decorative member 30, and the second heat generating body 36 and the second decorative member 32, are respectively in close contact with one another. This thereby enables heat transmission efficiency from the first heat generating body 34 and the second heat generating body 36 to the first decorative member 30 and the second decorative member 32 respectively to be secured.

Moreover, in the present exemplary embodiment, the coil springs 60, 62 are disposed between the surface portion 16A of the rim core metal section 16 and the inner face portion 34B of the first heat generating body 34, and between the surface portion 16A of the rim core metal section 16 and the inner face portion 36B of the second heat generating body 36, at plural locations in the axial direction of the rim core metal. The first heat generating body 34 and the second heat generating body 36 are accordingly supported at plural locations, enabling the first heat generating body 34 and the second heat generating body 36 to be disposed in a stable state with respect to the rim core metal section 16.

Moreover, the coil springs 60 press the first heat generating body 34 against the first decorative member 30, and the coil springs 62 press the second heat generating body 36 against the second decorative member 32, thereby enabling efficient heat transmission from the first heat generating body 34 and the second heat generating body 36 to the first decorative member 30 and the second decorative member 32 respectively. In addition, the outer face portion 34A of the first heat generating body 34 can be maintained in a state of abutting with the inner peripheral face portion 30A of the first decorative member 30, and the outer face portion 36A of the second heat generating body 36 can be maintained in a state of abutting with the inner peripheral face portion 32A of the second decorative member 32, even if the adhesive peels off.

In addition, in the present exemplary embodiment, the insertion holes 64 are formed to the first heat generating body 34, and the insertion holes 66 are formed to the second heat generating body 36, at plural respective locations in the rim core metal axial direction. The surface portion 16A of the rim core metal section 16 is provided with the plural first support portions 52 projecting out toward the first decorative member 30 side so as to correspond to the insertion holes 64 in the rim core metal axial direction. The surface portion 16A is also provided with the plural second support portions 54 projecting out toward the second decorative member 32 side so as to correspond to the insertion holes 66 in the rim core metal axial direction. The first support portions 52 are inserted through the insertion holes 64, and the first decorative member 30 is fixed to the leading end portions 52A of the first support portions 52. The second support portions 54 are inserted through the insertion holes 66, and the second decorative member 32 is fixed to the leading end portions 54A of the second support portions 54. This thereby enables the first decorative member 30 and the second decorative member 32 to be stably supported with respect to the rim core metal section 16, without the rim core metal section 16 making contact with the first heat generating body 34 and the second heat generating body 36.

Moreover, in the present exemplary embodiment, the first heat generating body 34 and the second heat generating body 36 are formed with the notch sections 68 at plural locations in the rim core metal axial direction. The plural first spacer members 56 and second spacer members 58 are disposed on the rim core metal section 16 so as to correspond to the notch sections 68 in the rim core metal axial direction. The exposed portions 56A of the first spacer members 56 which are exposed through the notch sections 68 abut the first decorative member 30, and the exposed portions 58A of the second spacer members 58 which are exposed through the notch sections 68 abut the second decorative member 32, respectively. This thereby enables relative displacement of the first decorative member 30 and the second decorative member 32 with respect to the rim core metal section 16 about the axial direction of the rim core metal section 16 to be suppressed.

The present exemplary embodiment accordingly enables the first decorative member 30 and the second decorative member 32 to be warmed, while suppressing load acting on the first heat generating body 34 and the second heat generating body 36.

### Supplementary Explanation Regarding the Above Exemplary Embodiment

(1) In the exemplary embodiment described above, the outer face portion 34A of the first heat generating body 34 and the inner peripheral face portion 30A of the first decorative member 30, and the outer face portion 36A of the second heat generating body 36 and the inner peripheral face portion 32A of the second decorative member 32, are joined together using an adhesive; however there is no limitation thereto. For example, configuration may be made such that the coil springs 60, 62 alone support the first heat generating body 34 with respect to the first decorative member 30, and support the second heat generating body 36 with respect to the second decorative member 32, without using an adhesive, such that relative displacement is permitted between thereby. This thereby enables the outer face portion 34A of the first heat generating body 34, and the outer face portion 36A of the second heat generating body 36, to be configured in a non-constrained state, and suppresses the effects of thermal expansion of the first decorative member 30 and the second decorative member 32 onto the first heat generating body 34 and the second heat generating body 36.

(2) In the exemplary embodiment described above, the coil springs 60, 62 are employed to support the first heat generating body 34 and the second heat generating body 36; however various resilient (elastic) members such as columnar rubber members, sponging bodies, or the like may be employed. Note that columnar resilient bodies may be integrally formed to the first spacer members 56 and/or the second spacer members 58 using a rubber material, sponging bodies, or the like.

Moreover, configuration may be made in which anchor portions are provided at the edge portions of the first decorative member 30 and the second decorative member 32, and these anchor portions are used to support the first heat generating body 34 and the second heat generating body 36, without using the coil springs 60, 62.

(3) In addition, in the exemplary embodiment described above, the first spacer members 56 and the second spacer members 58 suppress relative displacement of the first decorative member 30 and the second decorative member 32 with respect to the rim core metal section 16, however there is no limitation thereto. For example, configuration may be made in which the first support portions 52 and the second support portions 54 are increased in size to secure contact surface area between the leading end portion 52A of the first support portion 52 and the first decorative member 30, and to secure contact surface area between the leading end portion 54A of the second support portion 54 and the second decorative member 32. Such a configuration also enables relative displacement of the first decorative member 30 and the second decorative member 32 with respect to the rim core metal section 16 to be suppressed.

(4) Moreover, in the exemplary embodiment described above, the first support portions 52 and the second support portions 54 respectively support the first decorative member 30 and the second decorative member 32. However, resilient members like the coil springs 60, 62 may be disposed at the surface portion 16A of the rim core metal section 16 in place of the first support portion 52 and the second support portion 54.

What is claimed is:

1. A steering wheel structure comprising:
a rim core metal section that configures a portion of a frame of a steering wheel;
a decorative member that covers the rim core metal section, and that is gripped by an occupant; and
a heat generating body that includes an outer face portion which is joined to an inner peripheral face portion of the decorative member via a joining member and which transmits heat to the decorative member, and that includes an inner face portion which is disposed facing a surface portion of the rim core metal section via a space portion.

2. A steering wheel structure comprising:
a rim core metal section that configures a portion of a frame of a steering wheel;
a decorative member that covers the rim core metal section, and that is gripped by an occupant; and
a heat generating body that includes an outer face portion which abuts an inner peripheral face portion of the decorative member so as to be capable of relative displacement with respect to the inner peripheral face portion of the decorative member and which transmits heat to the decorative member, and that includes an inner face portion which is disposed facing a surface portion of the rim core metal via a space portion.

3. The steering wheel structure of claim 1, wherein:
resilient members that press the heat generating body toward the decorative member side, the resilient members being disposed between the surface portion and the inner face portion, and are disposed at a plurality of locations in an axial direction of the rim core metal section.

4. The steering wheel structure of claim 2, wherein:
resilient members that press the heat generating body toward the decorative member side, the resilient members being disposed between the surface portion and the inner face portion, and are disposed at a plurality of locations in an axial direction of the rim core metal section.

5. The steering wheel structure of claim 1, wherein:
insertion holes are formed at the heat generating body at a plurality of locations in an axial direction of the rim core metal section;
a plurality of support portions projecting out toward the decorative member side are provided at the surface portion so as to correspond to the insertion holes in the axial direction of the rim core metal; and
the decorative member is fixed to leading end portions of the support portions which are inserted through the insertion holes.

6. The steering wheel structure of claim 2, wherein:
insertion holes are formed at the heat generating body at a plurality of locations in an axial direction of the rim core metal section;
a plurality of support portions projecting out toward the decorative member side are provided at the surface portion so as to correspond to the insertion holes in the axial direction of the rim core metal; and
the decorative member is fixed to leading end portions of the support portions which are inserted through the insertion holes.

7. The steering wheel structure of claim 1, wherein:
notches are formed at the heat generating body at a plurality of locations in an axial direction of the rim core metal section;
a plurality of spacer members are disposed on the rim core metal so as to correspond to the notches in the axial direction of the rim core metal section; and
exposed portions of the spacer members which are exposed through the notches abut the decorative member.

8. The steering wheel structure of claim 2, wherein:
notches are formed at the heat generating body at a plurality of locations in an axial direction of the rim core metal section;
a plurality of spacer members are disposed on the rim core metal so as to correspond to the notches in the axial direction of the rim core metal section; and
exposed portions of the spacer members which are exposed through the notches abut the decorative member.
